(19) United States
(12) Patent Application Publication
(10) Pub. No.: US 2017/0338843 A1
(43) Pub. Date: Nov. 23, 2017

(54) IMPULSIVE NOISE DETECTION CIRCUIT AND ASSOCIATED METHOD

(71) Applicant: MStar Semiconductor, Inc., Hsinchu Hsien (TW)

(72) Inventors: Kun-Yu Wang, Hsinchu Hsien (TW); Ko-Yin Lai, Hsinchu Hsien (TW); Tai-Lai Tung, Hsinchu Hsien (TW)

(21) Appl. No.: 15/405,647

(22) Filed: Jan. 13, 2017

(30) Foreign Application Priority Data
May 17, 2016 (TW) 105115114

(51) Int. Cl. H04B 1/10; H04L 12/861; H04L 27/26

(52) U.S. Cl. CPC H04B 1/1036; H04L 49/9036; H04B 2001/1045; H04L 27/2601

(57) ABSTRACT

An impulsive noise detection method is applied to an orthogonal frequency-division multiplexing (OFDM) system to detect whether an input signal includes impulsive noise. The impulsive noise detection method includes receiving the input signal, converting the input signal to a digital input signal, filtering out a data band from the digital input signal to generate a signal under detection, calculating the signal under detection to generate a calculation result, and determining whether the input signal includes the impulsive noise according to the calculation result and a threshold.

This application claims the benefit of Taiwan application Serial No. 105115114, filed May 17, 2016, the subject matter of which is incorporated herein by reference.

### BACKGROUND OF THE INVENTION

### Field of the Invention

The invention relates in general to impulsive noise, and more particularly to an impulsive noise detection circuit and an associated method.

Description of the Related Art

Impulsive noise comes from sources including ignition systems of automobile engines and household appliances such as washing machines and hair dryers, and often appears in form of bursts. FIG. 1 shows a schematic diagram of impulse noise. A burst 1 and a burst 2 are two temporally consecutive bursts, each of which including a plurality of impulses. Impulse noise frequently exists in a cyclic form. One burst cycle is approximately 10⁻²s to 1s, the burst length is approximately 10⁻⁶s to 10⁻²s, and the length of one impulse is approximately 10⁻⁷s.

Impulsive noise is mixed in a data signal and may cause a decoding error when a data receiver decodes data. Conventionally, impulsive noise is detected based on the size of energy. For example, when the energy of impulsive noise is greater than the energy of a data signal, the impulsive noise is accordingly detected. However, when the energy of impulsive noise is smaller than the energy of a data signal, the impulsive noise may not be easily detected and thus cannot be further filtered out.

### SUMMARY OF THE INVENTION

The invention is directed to an impulsive noise detection circuit and an associated method to accurately detect impulsive noise.

The present invention discloses an impulse noise detection circuit for detecting whether an input signal includes impulsive noise. The impulsive noise detection circuit includes: a receiving circuit, receiving the input signal; an analog-to-digital converter (ADC), converting the input signal to a digital input signal; a filtering circuit, filtering out a data band from the digital input signal to generate a signal under detection; a calculation circuit, coupled to the filtering circuit, performing a moving average calculation on the detection under test to generate a calculation result; and a comparison circuit, coupled to the calculation circuit, determining whether the input signal includes the impulsive noise according to the calculation result and a threshold.

The present invention further discloses an impulsive noise detection method applied to an orthogonal frequency-division multiplexing (OFDM) system to detect whether an input signal includes impulsive noise. The impulsive noise detection method includes receiving the input signal, converting the input signal to a digital input signal, filtering out a data band from the digital input signal to generate a signal under detection; calculating the signal under detection to generate a calculation result; and comparing the calculation result and a threshold to determine whether the input signal includes the impulsive noise.

The impulsive noise detection circuit and method of the present invention are capable of detecting impulsive noise. As opposed to conventional technologies, the impulsive noise detection circuit and method of the present invention detect impulsive noise in a non-signal band, and are thus capable of detecting impulsive noise having an energy equal to or even smaller than that of a data signal.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of impulsive noise;

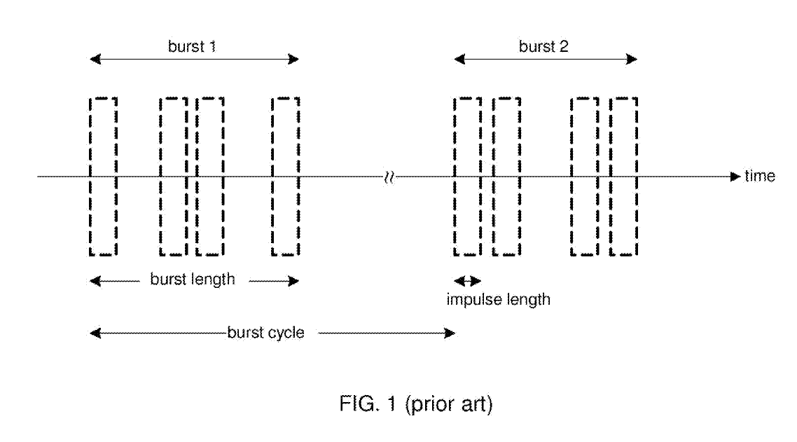

FIG. 2 is a block diagram of an impulsive noise detection circuit according to an embodiment of the present invention;

FIG. 3 is a flowchart of an impulsive noise detection method according to an embodiment of the present invention;

FIG. 4 is a spectrum diagram of zero intermediate frequency of an

ADC output signal;

FIG. 5 is a block diagram of a filtering circuit 110 according to an embodiment of the present invention;

FIG. 6 is a flowchart of a filtering step according to an embodiment of the present invention;

FIG. 7 is a block diagram of a calculation circuit 120 according to an embodiment of the present invention;

FIG. 8 is a flowchart of a calculating step according to an embodiment of the present invention;

FIG. 9 is a block diagram of an average calculating unit 126 according to an embodiment of the present invention; and

FIG. 10 is a schematic diagram of an output of a moving average calculating unit 124 of the present invention.

### DETAILED DESCRIPTION OF THE INVENTION

The disclosure of the application includes an impulsive noise detection circuit and method. In possible implementation, one skilled person in the art may choose equivalent elements or steps to implement the present invention based on the disclosure of the application. That is, the implementation of the present invention is not limited by the embodiments disclosed in the application.

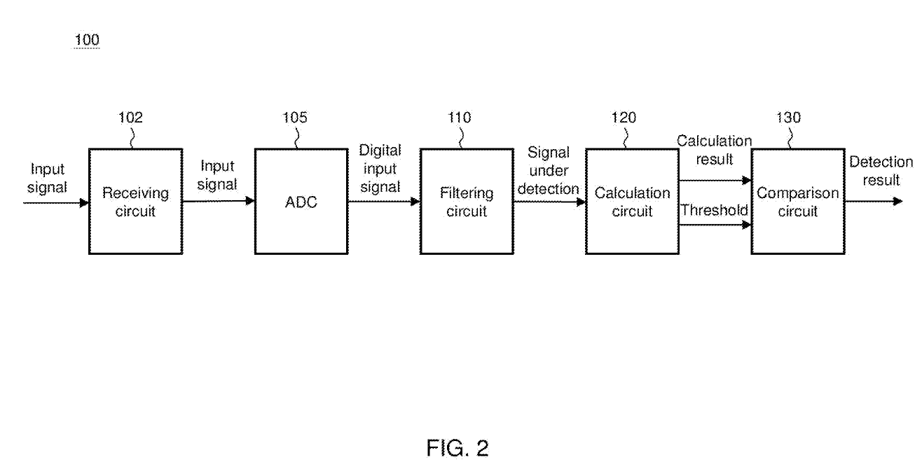

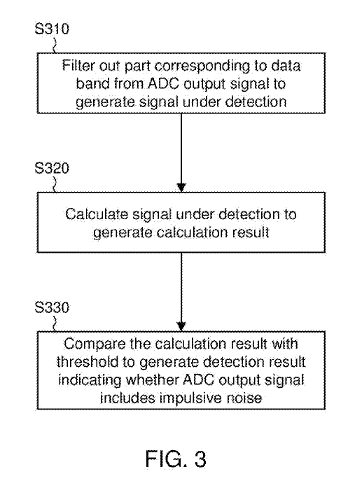

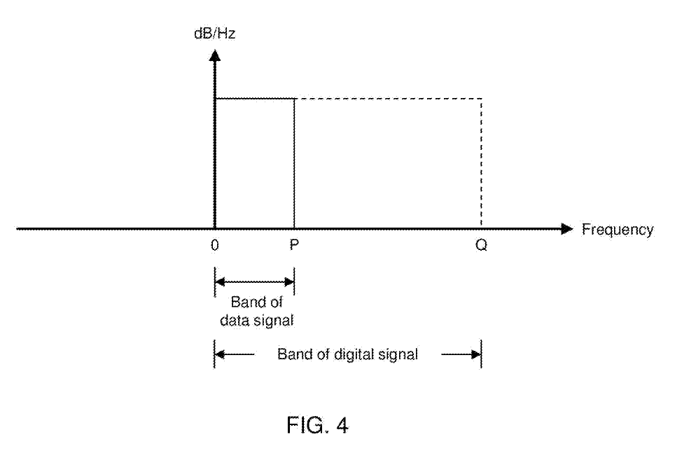

FIG. 2 shows a block diagram of an impulsive noise detection circuit according to an embodiment of the present invention. An impulsive noise detection circuit 100 detects impulsive noise in the digital domain, and includes a receiving circuit 102, an analog-to-digital converter (ADC) 105, a filtering circuit 110, a calculation circuit 120 and a comparison circuit 130. FIG. 3 shows a flowchart of an impulsive noise detection method according to an embodiment of the present invention. The filtering circuit 110 filters a digital signal outputted from the ADC 105 to filter out the part corresponding to data signal band from the outputted digital signal, and generates a signal under detection (step S310). FIG. 4 shows a spectrum diagram of a digital signal outputted from the ADC 105. The range between the frequency 0 and the frequency Q is a band of the digital signal outputted from the ADC 105, and the part that carries data in the digital signal is the band between the frequency 0 to the frequency P, i.e., the data signal band.

The impulsive noise occupies a rather large frequency range in the spectrum—it not only occupies an in-band part (i.e., the band between the frequency 0 and the frequency P) of the ADC output signal, but also extends to an out-band part (i.e., the band between the frequency P and the frequency Q). To prevent the component of the data signal in the ADC output signal from affecting the accuracy of impulsive noise detection, the impulsive noise detection circuit 100 detects only the out-band of the ADC output signal. The filtering circuit 110 of the impulsive noise detection circuit 100 uses one filter to filter out the part of the data signal, e.g., a band-pass filter or a low-pass filter. Thus, only the out-band part of the ADC output signal is preserved in the output of the filtering circuit 110, and becomes the signal under detection of the impulsive noise detection circuit 100. That is, the calculation circuit 120 and the comparison circuit 130 subsequently detect only the out-band part of the ADC output signal.

The calculation circuit 120 calculates the signal under detection, and outputs a calculation result (step S320). In practice, the calculation circuit 120 may generate the calculation result by calculating a temporal variance of the signal under detection and a moving average of the variance. The comparison circuit 130 then compares the calculation result with a threshold to generate a detection result (step S330). The detection result indicates whether the output signal includes impulse noise. Detailed circuits of the filtering circuit 110, the calculation circuit 120 and the comparison circuit 130 and detailed operations of steps S310 to S330 are described shortly.

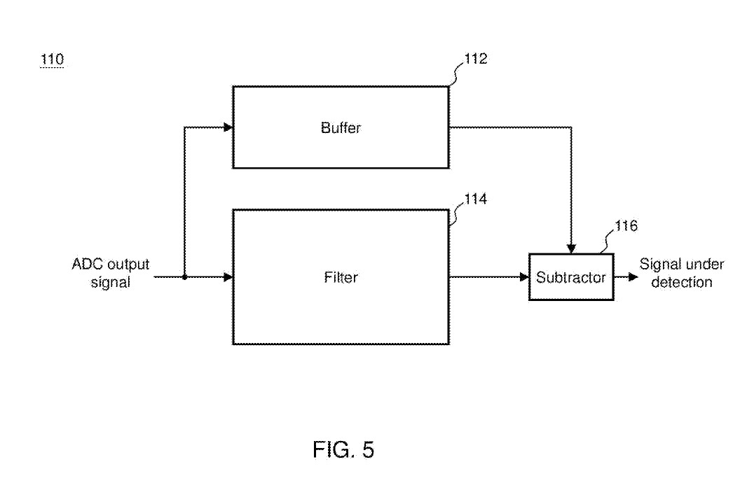

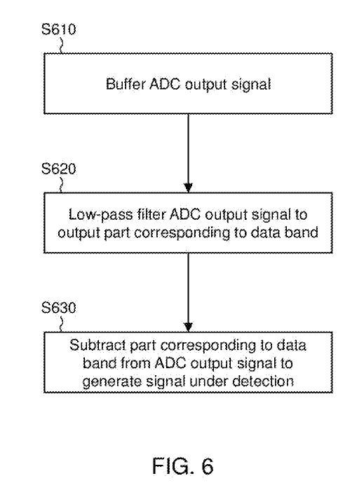

FIG. 5 shows a block diagram of the filtering circuit 110 according to an embodiment of the present invention. FIG. 6 shows a flowchart of the filtering step S310 according to an embodiment of the present invention. The filtering circuit 110 includes a buffer 112, a filter 114 and a subtractor 116. While being completely buffered in the buffer 112 (step S610), the ADC output signal also enters the filter 114 that removes the high-frequency part from the ADC output signal, i.e., filters the out-band part and outputs only the in-band part (step S620). The subtractor 116 then processes the output of the buffer 112 and the output of the filter 114. More specifically, the subtractor 116 subtracts the output of the filter 114 from the output of the buffer 112, i.e., subtracting the in-band part from the complete ADC output signal to output the out-band part of the ADC signal, to output the foregoing signal under detection (step S630). The subtractor 116 may be implemented by an operation circuit that performs subtraction. In this embodiment, because the filter 114 is a discrete time finite impulse response (FIR) filter, which adopts a plurality of delay circuits, weighted multipliers and adders, and may thus cause signal delay during operations. In one embodiment, the FIR filter adopts a direct form. When the filter adopts 2m+1 weighted multipliers (where m is a positive integer), the filter 114 outputs the calculation result of a 1^{st} sampling point at a time point at which an (m+1)^{th} sampling point is inputted. Thus, the size of the buffer needs to be equal to m+1, so that an output of the buffer may align with the output of the filter 114. Assuming that 2m+1 sampling points (where m is a positive integer) are included between the frequency 0 and the frequency P, the filter 114 outputs the calculation result of the 1^{st} sampling point at a time point at which the (m+1)^{th} sampling point is inputted. Thus, the size of the buffer 112 needs to be equal to m+1, so that the output of the buffer 112 may align with the output of the filter 114. In another embodiment, the FIR filter adopts a lattice form. That is, when the filter adopts n weighted multipliers (where n is a positive integer), the filter 114 outputs the calculation result of the 1^{st} sampling point at a time point at which the n^{th} sampling point is inputted. Thus, the size of the buffer needs to be equal to n in order to have the output of the buffer align with the output of the filter 114. It should be noted that, an orthogonal frequency-division multiplexing (OFDM) system (for example but not limited to, a Digital Video Broadcasting over Terrestrial 2 (DVB-T2)) usually includes one filter that removes adjacent channel interference (ACI). When the present invention is applied to an OFDM system, the ACI filter may be directly used as the filter 114 of the present invention to reduce circuit costs. Further, although the filtering circuit 110 filters out the data band of the ADC output signal by using a combination of the buffer 112, the filter 114 and the subtractor 116 in this embodiment, the filtering circuit 110 in different embodiments may achieve the same object using a band-pass filter.

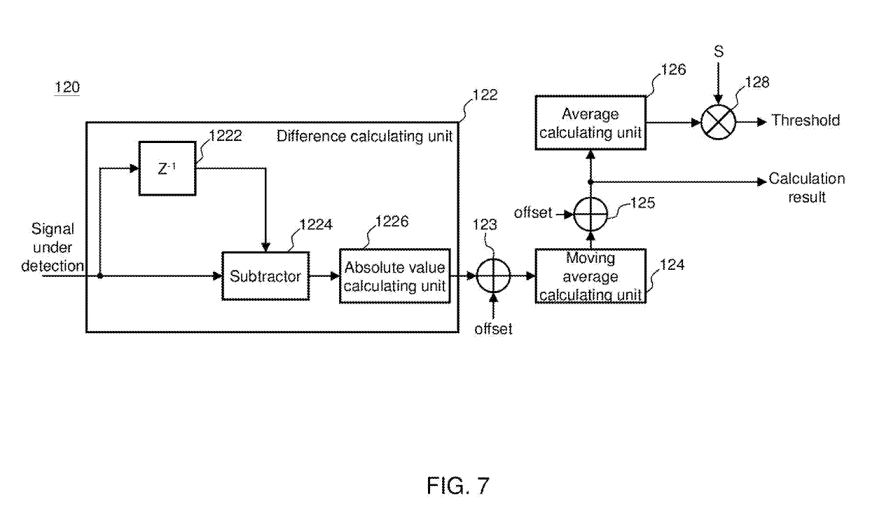

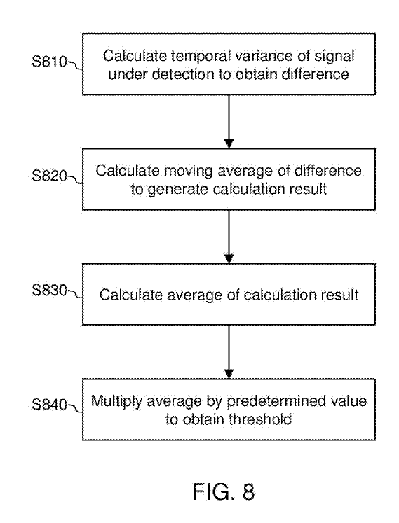

FIG. 7 shows a block diagram of the calculation circuit 120 according to an embodiment of the present invention. FIG. 8 shows a detailed flowchart of the calculating step S320 according to an embodiment of the present invention. The calculation circuit 120 includes a difference calculating unit 122, a moving average calculating unit 124, an average calculating unit 126 and a multiplier 128. The difference calculating unit 122 includes a delay unit 1222, a subtractor 1224 and an absolute value calculating unit 1226. The primary function of the difference calculating unit 122 is calculating a temporal variance of the signal under detection to obtain a difference (step S810). More specifically, the subtractor 1224 calculates a difference between the current signal under detection and a previous signal under detection (i.e., an output of the delay unit 1222), and the absolute value calculating unit 1226 then calculates an absolute value of the difference. When the signal under detection is in a real number, the absolute value calculating unit 1226 purely calculates the absolute value of the difference; when the signal under detection is in a complex number (e.g., when the present invention is applied to an OFDM system), the absolute value calculating unit 1226 calculates, e.g., a 1-norm of the difference.

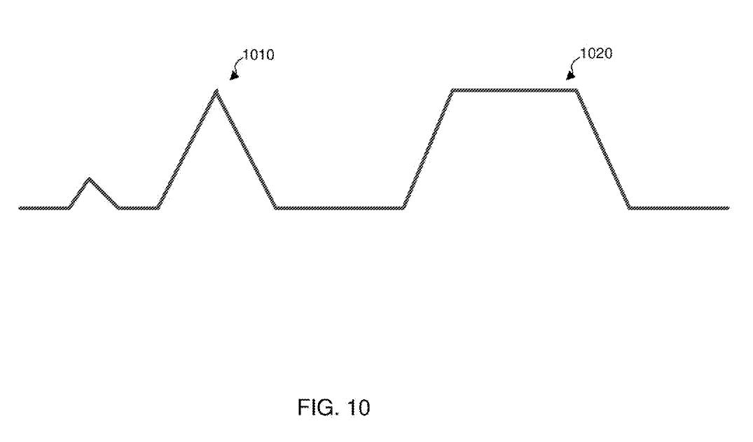

Next, the moving average calculating unit 124 calculates a moving average of the difference and generates the calculation result (step S820). Details for calculating the moving average are generally known to one person skilled in the art, and shall be omitted. When the impulsive noise is present, the difference that the difference calculating unit 122 outputs shows a larger value within a short period (i.e., corresponding to a period in which bursts appear). To prevent the impulsive noise detection circuit 100 of the present invention from misjudging impulsive signals that are non-impulsive noise as impulsive noise, the effect of the impulsive signals are alleviated by means of moving averaging. Further, in the comparison circuit 130, a mechanism is designed based on the properties of impulsive noise to further determine whether impulsive noise exists. When real impulsive noise exists, the output of the moving average calculating unit 124 (i.e., the calculation result) displays a triangle-like waveform (e.g., a region 1010 in FIG. 10). When real impulsive noise exists and the window length of the moving average calculating unit 124 is shorter than the burst length, the output of the moving average calculating unit 124 (i.e., the calculation result) displays waveform with a plateau effect (e.g., a region 1020 in FIG. 10). In fact, this calculation result sufficiently reflects whether impulsive noise exists in the ADC output signal. For example, the backend comparison circuit 130 may directly compare the calculation result with a threshold in a constant value, and may determine that impulsive noise exists when the calculation result is greater than the threshold in a constant value. However, the level of interference from impulsive noise may differ as real application environments of electronic devices vary, and so an accurate determination may not be performed if a threshold in a constant value is used as a determination standard.

To enhance the determination accuracy of the impulsive noise detection circuit 100 of the present invention, the present invention further compares the calculation result with a dynamic threshold that is associated with the calculation result. As shown in FIG. 7, the average calculating unit 126, coupled to the moving average calculating unit 124, calculates an average of the calculation result (step S830), and the multiplier 128 then multiplies the average by a predetermined value S to obtain the dynamic threshold (step S840). The average value calculating unit 126 calculates the average value according to an equation:

$$\begin{matrix}MA\_avg [ n ] {=}^{△} \frac{1}{M} \times {\sum }_{l = 0}^{M - 1} MA [ n - l ] \\ = \frac{1}{M} \times MA [ n ] + \frac{1}{M} \times {\sum }_{l = 1}^{M - 1} MA [ n - l ] \\ = \frac{1}{M} \times MA [ n ] + \frac{M - 1}{M} \cdot \frac{1}{M - 1} \times {\sum }_{{l}^{′} = 0}^{M - 2} MA [ n - 1 - {l}^{′} ] \\ ≅ α \cdot MA [ n ] + ( 1 - α ) \cdot MA\_avg [ n - 1 ]\end{matrix}$$

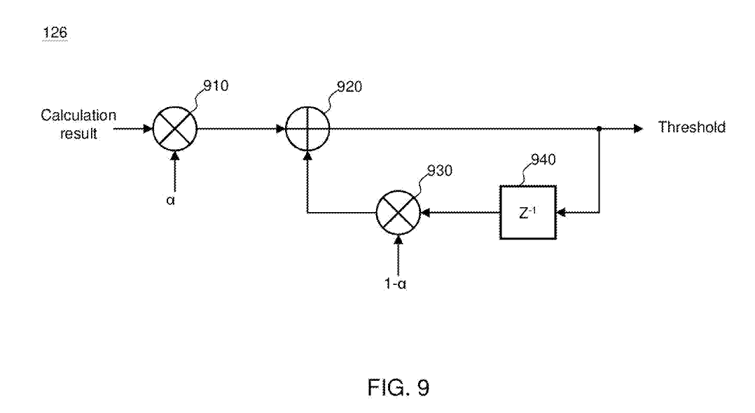

In the above, MA[n] is the calculation result, MA_avg[n] is the average of the calculation result, 1/M means averaging M calculation results, I′=I-1 and α=1/M. FIG. 9 shows a circuit of the average calculating unit 126. A multiplier 910 multiplies the calculation result MA[n] by α, a multiplier 930 multiplies a delayed threshold MA_avg[n−1] (i.e., an output of a delay unit 940) by (1−α), and an adder 920 adds the result of the multiplier 910 and the result of the multiplier 930 to obtain a new threshold. The predetermined value S is generally greater than 1.

Next, the comparison circuit 130 compares calculation result outputted by the calculation circuit 120 with the dynamic threshold (i.e., performing the comparison step S330), and determines that impulsive noise exists when the calculation result is greater than the dynamic threshold.

However, as previously described, electronic devices may suffer from impulsive noise having different properties. Thus, the present invention further sets different predetermined time ranges according to different properties of impulsive noise under detection to obtain an optimal determination effect. For example, when the calculation result is greater than the threshold for a duration that lasts within a predetermined time range, the comparison circuit 130 determines that the ADC output signal includes predetermined impulsive noise, wherein the predetermined time range is determined according to the properties of the impulsive noise. Further, a window length that the moving average calculating unit 124 uses or a window length used for calculating the moving average in step S820 may be set according to the length of bursts under detection to achieve an optimal determination result. For example, assume that the sampling frequency of an ADC is 25 MHz. Based on a test model for impulsive noise (e.g., Vol. 3 of Part A of DTG D-Book, Ver. 7), when the length of bursts is between 1 μs and 40,000μs, the magnitude of sample count of the ADC corresponding to each burst is approximately between 10² and 10⁶. That is to say, it may be designed that, when the comparison circuit 130 determines that the calculation result is greater than the threshold for a duration between [x1+L_{buff}, x2+L_{buff}], a detection result indicates the presence of impulsive noise, wherein x1 and x2 are positive integers (x1<x2), the magnitude is in general between 10² and 10⁶ (depending on actual operation environments), and L_{buff} is a window length that the moving average calculating unit 124 uses or a window length used for calculating the moving average in step S820.

It should be noted that, when a dynamic threshold is selected, the calculation result outputted by the moving average calculating unit 124 (or generated in step S820) approaches 0 in the absence of impulsive noise, and the average value of the calculation result and the threshold also approach 0. In this above situation, it is likely that the comparison circuit 130 is caused to misjudge. To prevent such misjudgment, before or after the moving average calculating unit 124, the present invention may selectively add a direct-current (DC) level offset (corresponding to between step S810 and step S820 in FIG. 8, or adding a DC level adjusting step between step S820 and step S830) to the signal by using a DC adjusting circuit. More specifically, a DC level offset may be added to the difference outputted from the difference calculating unit 122 (using the adder 123 in FIG. 7), or a DC level offset may be added to the calculation result outputted from the moving average calculating unit 124 (by the adder 125 in FIG. 7). For example, the DC level offset is a positive integer greater than 0. When impulsive noise does not exist, the calculation result and its average both approach the DC level offset instead of 0. When the predetermined value S is greater than 1, the threshold obtained from multiplying the average value and the predetermined value S is greater than the DC level offset. As such, the threshold may be distinguished from the calculation result that is not affected by impulsive noise to prevent misjudgment.

One person skilled in the art can understand the implementation details and variations of the method in FIG. 3, FIG. 6 and FIG. 8 based on the disclosure associated with the circuit in FIG. 2, FIG. 5, FIG. 7 and FIG. 9 of the present invention. While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An impulsive noise detection circuit, for detecting whether an input signal comprises impulsive noise, comprising:
a receiving circuit, receiving the input signal;
an analog-to-digital converter (ADC), coupled to the receiving circuit, converting the input signal to a digital input signal;
a filtering circuit, coupled to the ADC, filtering out a data band from the digital input signal to generate a signal under detection;
a calculation circuit, coupled to the filtering circuit, performing a moving average calculation according to the signal under detection to generate a calculation result; and
a comparison circuit, coupled to the calculation circuit, comparing the calculation result with a threshold to determine whether the input signal comprises the impulsive noise.

2. The impulsive noise detection circuit according to claim 1, applied to an orthogonal frequency-division multiplexing (OFDM) system, wherein the filtering circuit comprises:
a filter, filtering the digital input signal to output the data band;
a buffer, buffering the digital input signal; and
a subtractor, coupled to the filter and the buffer, subtracting the data band from the digital input signal to generate the signal under detection;
wherein, the filter is an adjacent channel interference (ACI) filter of the OFDM system.

3. The impulsive noise detection circuit according to claim 2, wherein the ACI filter is a band-pass filter.

4. The impulsive noise detection circuit according to claim 2, wherein the filter is a discrete time finite impulse response (FIR) filter, which comprises a plurality of delay circuits, a plurality of weighted multipliers and a plurality of adders, and a size of the buffer is associated with the number of the weighted multipliers.

5. The impulsive noise detection circuit according to claim 1, wherein the calculation circuit comprises:
a difference calculating unit, calculating a temporal variance of the signal under detection to obtain a plurality of differences; and
a moving average calculating unit, coupled to the difference calculating unit, calculating a moving average of the differences to generate the calculation result.

6. The impulsive noise detection circuit according to claim 5, wherein a window length of the moving average calculating unit is associated with a burst length of the impulsive noise.

7. The impulsive noise detection circuit according to claim 5, wherein the calculation circuit further comprises:
an average calculating unit, coupled to the moving average calculating unit, calculating an average of the calculation result; and
a multiplier, coupled to the average calculating unit, multiplying the average by a predetermined value to obtain the threshold;
wherein, the predetermined value is greater than 1.

8. The impulsive noise detection circuit according to claim 5, wherein the calculation circuit further comprises:
a direct-current (DC) level adjusting circuit, coupled to the moving average calculating unit, causing the differences or the calculation result to have a DC level offset;
wherein, the threshold is greater than the DC level offset.

9. The impulsive noise detection circuit according to claim 1, wherein when the comparison circuit determines that the calculation result is greater than threshold, it is determined that the digital input signal comprises the impulsive noise.

10. The impulsive noise detection circuit according to claim 1, wherein when the comparison circuit determines that the calculation result is greater than the threshold for a duration that lasts for a predetermined time range, it is determined that the digital input signal comprises the impulsive noise, and the predetermined time range is associated with properties of the impulsive noise.

11. An impulsive noise detection method, applied to an orthogonal frequency-division multiplexing (OFDM) system, for detecting whether an input signal comprises impulsive noise, the impulsive noise detection method comprising:
receiving the input signal;
converting the input signal to a digital input signal;
filtering out a data band from the digital input signal to generate a signal under detection;
performing a moving average calculation according to the signal under detection to generate a calculation result; and
comparing the calculation result with a threshold to determine whether the input signal comprises the impulsive noise.

12. The impulsive noise detection circuit according to claim 11, wherein the step of filtering out the data band from the digital input signal to generate the signal under detection comprises:
filtering the digital input signal by an adjacent channel interference (ACI) filter of the OFDM system to output the data band of the digital input signal;
buffering the digital input signal; and
subtracting the data band from the digital input signal to generate the signal under detection.

13. The impulsive noise detection circuit according to claim 12, wherein the ACI filter filters the digital input signal using band-pass filter.

14. The impulsive noise detection circuit according to claim 11, wherein the calculating step comprises:
calculating a temporal variance of the signal under detection to obtain a plurality of differences; and
calculating a moving average of the differences to generate the calculation result.

15. The impulsive noise detection circuit according to claim 14, wherein in the step of calculating the moving average of the differences to generate the calculation result, a window length used is associated with a burst length of the impulsive noise.

16. The impulsive noise detection circuit according to claim 14, wherein the
calculating step further comprises:
calculating an average of the calculation result; and
multiplying the average by a predetermined value to obtain the threshold;
wherein, the predetermined value is greater than 1.

17. The impulsive noise detection circuit according to claim 14, further comprising:
adjusting the differences or the calculation result to cause the differences or the calculation result to have a DC level offset;
wherein, the threshold is greater than the DC level offset.

18. The impulsive noise detection circuit according to claim 11, wherein when the calculation result is greater than threshold, it is determined that the digital input signal comprises the impulsive noise.

19. The impulsive noise detection circuit according to claim 11, wherein when the calculation result is greater than the threshold for a duration that lasts for a predetermined time range, it is determined that the digital input signal comprises the impulsive noise, and the predetermined time range is associated with properties of the impulsive noise.
